(19) United States
(12) Patent Application Publication
(10) Pub. No.: US 2008/0086507 A1
(43) Pub. Date: Apr. 10, 2008

(54) Automated Letters Patent Analysis Support System and Method

(75) Inventors: Mark A. Szygenda, Pflugerville, TX (US); Stephen A. Szygenda, Dallas, TX (US)

Correspondence Address: HITT GAINES, PC;LSI Corporation, PO BOX 832570, RICHARDSON, TX, 75083, US

(73) Assignee: Intelligent Process Expert Systems, LLC, Dallas, TX (US)

(21) Appl. No.: 11/672,594

(22) Filed: Feb. 8, 2007

Related U.S. Application Data
(60) Provisional application No. 60/828,550, filed on Oct. 6, 2006.

(51) Int. Cl. G06F 17/00

(52) U.S. Cl. 707/104.1

(57) ABSTRACT

An automated letters patent analysis support system and method. In one embodiment, the system includes: (1) a document parser configured to scan at least one item in target letters patent and derive therefrom a set of key parameters, (2) a rule generator associated with the document parser and configured iteratively to: (2a) solicit user input regarding key parameters to be included in the set, (2b) employ the set to generate search rules to be used for searching and (2c) solicit the user input regarding the search rules, (3) an iterative domain searcher associated with the rule generator and configured iteratively to: (3a) search a target search domain for the key parameters using the search rules and (3b) provide at least one interim report containing occurrences of at least some of the key parameters in the target search domain and (4) a chart generator associated with the iterative domain searcher and configured to generate a chart regarding the item and based on the at least one interim report.

### CROSS-REFERENCE TO RELATED APPLICATION

This application is based on and claims priority of U.S. Provisional Application Ser. No. 60/828,550, filed by Szygenda, et al., on Oct. 6, 2006, entitled “Method and System for Dissecting Patent Information,” incorporated herein by reference and commonly assigned with the invention that is the subject matter of this application.

### TECHNICAL FIELD OF THE INVENTION

The invention is directed, in general, to computer software for analyzing documents and, more particularly, to software-based automated support systems and methods that support analyses of letters patent.

### BACKGROUND OF THE INVENTION

Technical and patent law professionals are routinely called upon to analyze letters patent. Such analysis may attend the design of a new product, asset valuation, license negotiations or threatened or actual infringement litigation.

Letters patent are documents that evidence patents. Patents, as used herein, are intangible, exclusive rights granted by governments to inventors allowing them to exclude others from making, using or selling their inventions for a limited time. Letters patent typically contain a background of the invention, which conveys the environment within which the invention arose and typically includes problems, challenges and opportunities that the invention addresses. Letters patent also contain a written description of the invention, which typically includes an abstract, a summary, drawing figures and brief and detailed descriptions of those drawing figures. The abstract, background, summary, drawing figures and brief and detailed descriptions are collectively referred to as the specification. Finally, letters patent contain claims, which are single-sentence statements that legally define the invention, to varying degrees of specificity, that the patent covers. To infringe a patent is to make, use or sell an apparatus, composition or method that falls within the scope of at least one claim of that patent.

To receive patent protection, an invention must meet legal prerequisites of patentability. In the United States, an invention must fall within the allowable subject matter for a patent and be novel and nonobvious in view of “prior art,” useful and supported by a written description that is adequate to enable the invention to be made and practiced and discloses the “best mode” of practicing the invention. Applications for patent undergo a formal examination process by a patent examiner employed in a patent office to ensure that these legal prerequisites are met. This examination process is captured in a set of documents called a prosecution history that are made publicly available.

As stated above, technical and patent law professionals are routinely called upon to analyze letters patent. Such analysis falls into two general categories: validity (including enforceability) and infringement. For both categories, the scope and meaning of words and phrases used in the claims are often at issue. For validity, the issue may also involve the adequacy of antecedent basis (or “support”) in the specification for those words or phrases or novelty or nonobviousness in view of the prior art. For infringement, the issue may also involve whether or not the claims “read on” the accused infringing device, composition or method.

The analysis of letters patent is typically long, tedious, manual and exacting. What is needed in the art is a way to support the analysis of letters patent such that the technical or patent law professional is relieved of some of the more tedious aspects. What is further needed in the art is a way to increase the speed at which the analysis of letters patent can be performed without sacrificing any of the accuracy of that analysis. What is still further needed in the art is a software tool that supports the analysis of letters patent by automating certain aspects of it.

### SUMMARY OF THE INVENTION

To address the above-discussed deficiencies of the prior art, the invention provides, in one aspect, an automated letters patent analysis support system. In one embodiment, the system includes: (1) a document parser configured to scan at least one item in target letters patent and derive therefrom a set of key parameters, (2) a rule generator associated with the document parser and configured iteratively to: (2a) solicit user input regarding key parameters to be included in the set, (2b) employ the set to generate search rules to be used for searching and (2c) solicit the user input regarding the search rules, (3) an iterative domain searcher associated with the rule generator and configured iteratively to: (3a) search a target search domain for the key parameters using the search rules and (3b) provide at least one interim report containing occurrences of at least some of the key parameters in the target search domain and (4) a chart generator associated with the iterative domain searcher and configured to generate a chart regarding the item and based on the at least one interim report. In another embodiment, the system includes: (1) a document parser configured to scan claims in target letters patent and derive therefrom a set of limitations therefrom, (2) a rule generator associated with the document parser and configured iteratively to: (2a) solicit user input regarding limitations to be included in the set, (2b) employ the set to generate search rules to be used for searching and (2c) solicit the user input regarding the search rules, (3) an iterative domain searcher associated with the document parser and configured iteratively to: (3a) search a target search domain for the limitations and (3b) provide interim reports containing occurrences of at least some of the limitations in the target search domain and (4) a claim chart generator associated with the iterative domain searcher and configured to generate a claim chart based on the interim report.

In another aspect, the invention provides an automated letters patent analysis support method. In one embodiment, the method includes: (1) scanning at least one claim in target letters patent, (2) deriving from the target letters patent a set of key parameters, (3) iteratively: (3a) soliciting user input regarding key parameters to be included in the set, (3b) employing the set to generate search rules to be used for searching, (3c) soliciting the user input regarding the search rules, (3d) searching a target search domain for the key parameters using the search rules and (3e) providing an interim report containing occurrences of at least some of the key parameters in the target search domain and (4) generating a claim chart based on the interim report.

The foregoing has outlined preferred and alternative features of the invention so that those skilled in the pertinent art may better understand the detailed description of the invention that follows. Additional features of the invention will be described hereinafter that form the subject of the claims of the invention. Those skilled in the pertinent art should appreciate that they can readily use the disclosed conception and specific embodiment as a basis for designing or modifying other structures for carrying out the same purposes of the invention. Those skilled in the pertinent art should also realize that such equivalent constructions do not depart from the scope of the invention.

### BRIEF DESCRIPTION OF THE DRAWINGS

For a more complete understanding of the invention, reference is now made to the following descriptions taken in conjunction with the accompanying drawings, in which:

FIG. 1 illustrates a block diagram of one embodiment of a system for performing automated letters patent analysis support constructed according to the principles of the invention;

FIG. 2 illustrates a flow diagram of one embodiment of a method of performing automated letters patent analysis support carried out according to the principles of the invention;

FIG. 3 illustrates a block diagram of one embodiment of a dissector process that may be carried out in the system of FIG. 1 or the method of FIG. 2;

FIG. 4 illustrates a block diagram showing how a document, such as letters patent, may be partitioned according to the dissector process of FIG. 3;

FIG. 5 is a diagram illustrating the generation of search rules pertaining to letters patent in accordance with the system of FIG. 1 or the method of FIG. 2;

FIG. 6 illustrates a flow diagram of one embodiment of a more detailed first portion of the method of FIG. 2;

FIG. 7 illustrates a flow diagram of one embodiment of a more detailed second portion of the method of FIG. 2;

FIG. 8 illustrates a flow diagram of one embodiment of a more detailed third portion of the method of FIG. 2;

FIG. 9 illustrates a flow diagram of one embodiment of a more detailed fourth portion of the method of FIG. 2;

FIG. 10 illustrates a flow diagram of one embodiment of a more detailed fifth portion of the method of FIG. 2;

FIG. 11 illustrates a flow diagram of one embodiment of a more detailed sixth portion of the method of FIG. 2;

FIG. 12 illustrates one embodiment of a first interim report, a key parameter search report, that may be generated by the system of FIG. 1 or the method of FIG. 2;

FIG. 13 illustrates one embodiment of a second interim report, a details of analysis and summary of coverage report pertaining to an anticipation analysis, that may be generated by the system of FIG. 1 or the method of FIG. 2;

FIG. 14 illustrates one embodiment of a third interim report, a details of analysis and summary of coverage report pertaining to an obviousness analysis, that may be generated by the system of FIG. 1 or the method of FIG. 2;

FIG. 15 illustrates one embodiment of a fourth interim report, a summary of coverage report pertaining to a motivation to combine analysis, that may be generated by the system of FIG. 1 or the method of FIG. 2; and

FIG. 16 illustrates one embodiment of a claim chart that may be generated by the system of FIG. 1 or the method of FIG. 2.

### DETAILED DESCRIPTION

Before describing various embodiments of the system and method of the invention, it should be noted that many of the embodiments to be described relate to letters patent, and the analyses performed on such letters patent relate to patentability, validity, enforceability and infringement. However, those skilled in the pertinent art will readily understand that the principles of the invention extend to any type of analysis performed on any type of document. Thus, for example, the principles of the invention extend to analyzing research papers for related work, term papers for plagiarism and news stories for context.

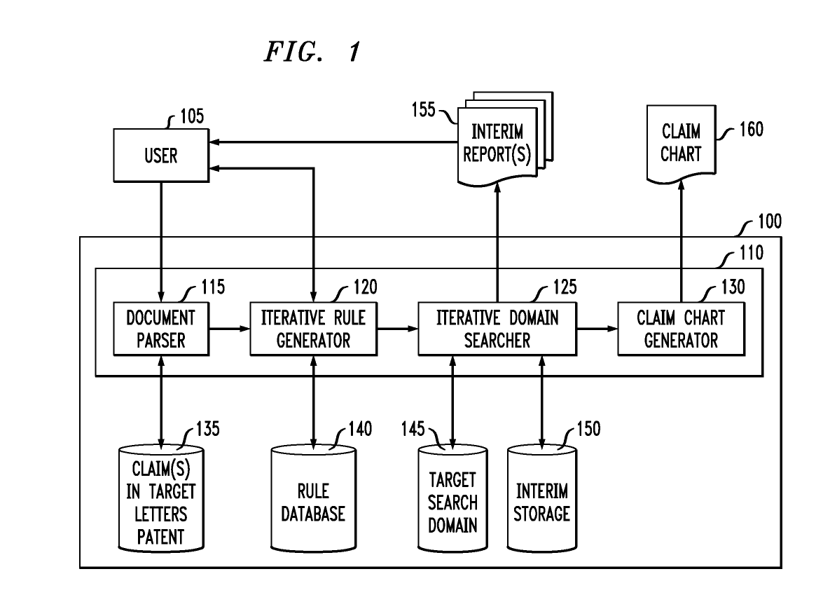

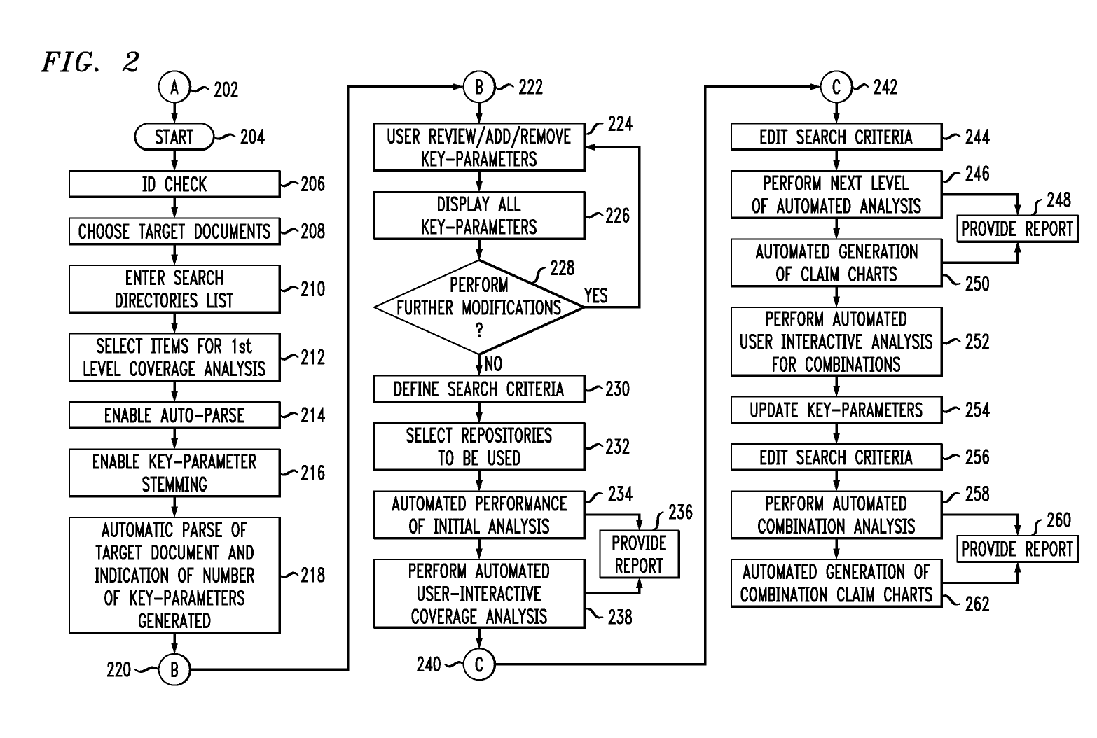

Referring initially to FIG. 1, illustrated is a block diagram of one embodiment of a system for performing automated letters patent analysis support constructed according to the principles of the invention. A general-purpose data processing and storage device 100, such as a personal computer or a network server interacts with a user 105, who may be a technical or patent law professional, and also hosts the system, which is generally designated 110. Those skilled in the pertinent art will understand that the system of the invention may be implemented on a stand-alone computer or over a network, e.g., the Internet.

The illustrated embodiment of the system 110 includes a document parser 115, a rule generator 120, an iterative domain searcher 125 and a claim chart generator 130. The document parser 115 is configured to scan at least one claim in target letters patent 135. During that scanning, the document parser 115 derives from the target letters patent 135 a set of key parameters. For purposes of the invention, a key parameter is defined as one or more numerals or typographical symbols or a word fragment, word, set of words, phrase, acronym, claim limitation or claim element upon which a search may be performed. The key parameters are often derived from the claims (as FIG. 1 shows), although they may alternatively or additionally be derived from the specification.

The rule generator 120 is associated with the document parser 115. The rule generator 120 is configured iteratively to solicit user input regarding key parameters to be included in the set, employ the set to generate search rules to be used for searching and solicit the user input regarding the search rules. In this regard, the rule generator 120 may interact with a rule database 140 in which the set of search rules may be contained, for future use or for artificial intelligence learning algorithms or heuristics.

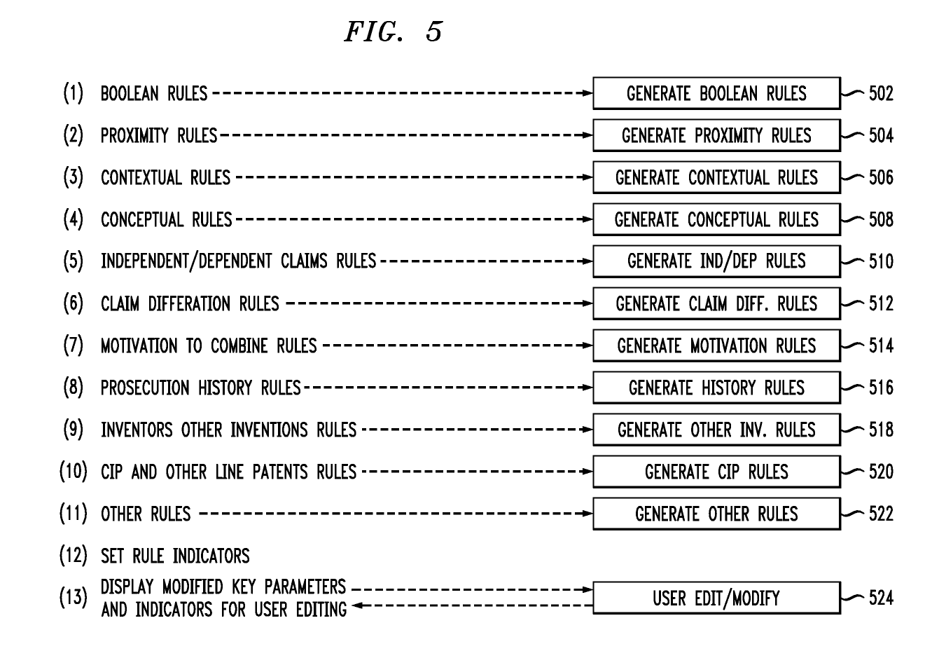

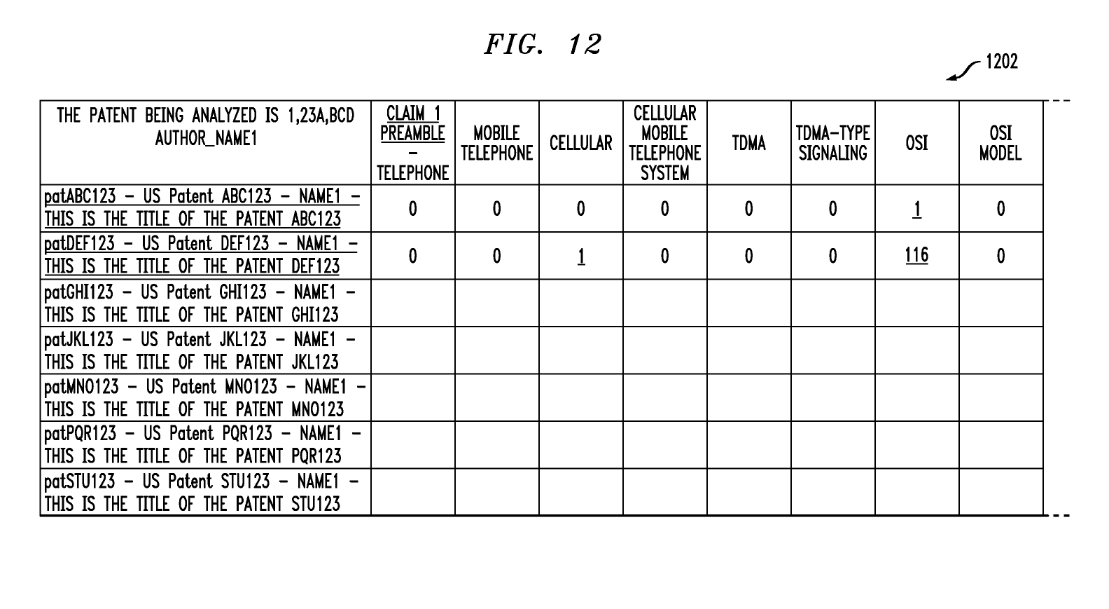

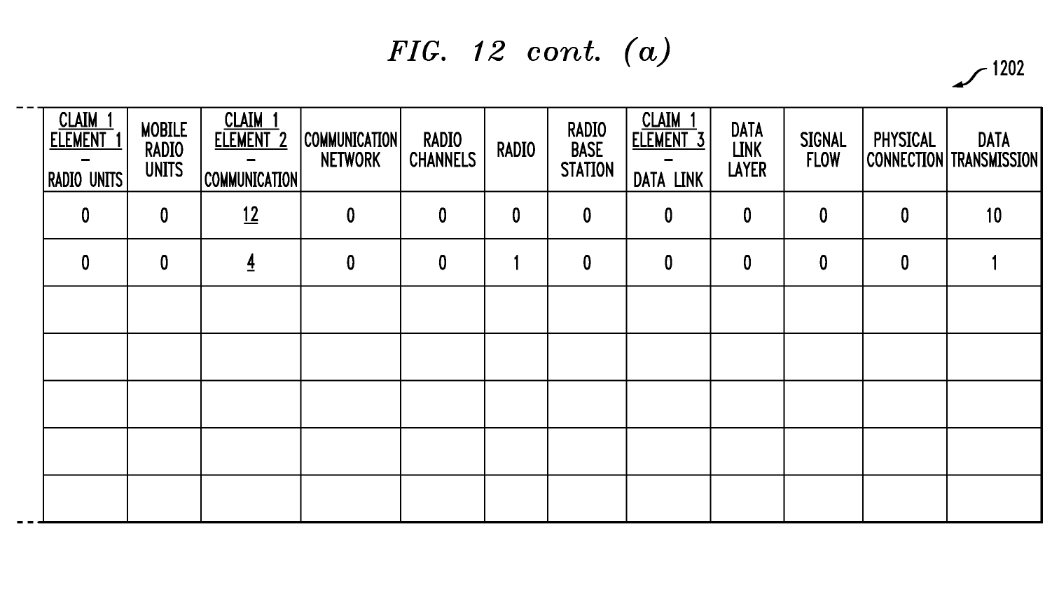

Those skilled in the pertinent art are familiar with search rules and their use in searching. Some example search rule types will be set forth in conjunction with FIG. 5, below, but may be any type of characterization of a single key parameter or association between or among multiple key parameters upon which a search may be based. Further, some examples of the manner in which the rule generator 120 may solicit user input regarding key parameters to be included in the set of key parameters, employ the set to generate search rules to be used for searching and solicit the user input regarding the search rules will be set forth in conjunction with FIGS. 8, 10 and 11, below.

Some embodiments of the rule generator 120 may learn over time. For example, if a particular search rule is found over the course of multiple searches to exhibit a particular efficacy (e.g., uncovering relevant references while ignoring irrelevant references), the rule generator 120 may learn to prefer the search rule and proffer it to the user. Likewise, the rule generator 120 may de-emphasize a search rule that has a history of being disadvantageous (e.g., drastically lengthens or complicates the search with little marginal benefit). Those skilled in the pertinent art understand how a rule generator may be made to score the efficacy of search rules and base their future use or suggestion as a function thereof.

The iterative domain searcher 125 is associated with the rule generator 120. The iterative domain searcher 125 is configured iteratively to search a target search domain 145 for the key parameters and provide one or more interim reports 155 containing occurrences of at least some of the key parameters in the target search domain 145.

As will be described in greater detail below, once the document parser 115 derives an initial set of key parameters, the user 105 may refine that set by adding or deleting key parameters as judgment dictates. Then, when the user 105 is finished, the rule generator 120 generates an initial set of search rules. Then, iterative domain searcher 125 searches the target search domain 145 for occurrences of the key parameters in various references (e.g., prior art patents or publications) contained therein.

The target search domain 145 may be the specification or prosecution history of the target letters patent (useful for determining definitions, antecedent basis, equivalents or prosecution history estoppel) or one or more local or online databases (useful for determining patentability, validity, equivalents or enforceability), which are structured or unstructured repositories for storing data. For example, the user may want the iterative domain searcher 125 to search one or more local database containing references of interest. Alternatively or additionally, the user 105 may want the iterative domain searcher 125 to search one or more online databases for references of interest. The user 105 may specify one or more online databases to search, or may cause the iterative domain searcher 125 to “troll” for references over a plurality of online databases, such as over the Internet. To improve search speed, particularly in subsequent iterations, the iterative domain searcher 125 may store references retrieved from the target search domain in interim storage 150.

The iterative domain searcher 125 then provides the one or more interim reports 155, examples of which to be set forth below. The interim report(s) 155 may indicate when a key parameter of a given claim has no occurrences in the target search domain (perhaps indicating a lack of antecedent basis in the specification or a potential deficiency in a reference). The interim report(s) 155 may indicate when a single reference in the target search domain contains all key parameters of a given claim (perhaps indicating an anticipating reference). The interim report(s) 155 may indicate when a combination of references in the target search domain contains all key parameters of a given claim (perhaps indicating a combination of references that constitute prima facie obviousness). The interim report(s) 155 may be printed on paper, as shown, or displayed on a display device coupled to the general-purpose data processing and storage device 100.

Based on the interim report(s) 155, the user then may choose to expand or contract the set of key parameters, add, modify or delete search rules, search in a different or additional target search domain 145 or otherwise refine or modify the search. The iterative domain searcher 125 then repeats the process of searching the target search domain 145 (or some subset of the target search domain 145 that has been identified through previous searches or as specified by the user 105) and producing interim report(s) 155.

At some point, the user 105 becomes satisfied regarding the search(es) performed. The claim chart generator 130 may then be invoked. The claim chart generator 130 is associated with the iterative domain searcher 125. The claim chart generator 130 is configured to generate a claim chart 160 based on the one or more interim reports 155. The claim chart 160 may be printed on paper, as shown, or displayed on a display device coupled to the general-purpose data processing and storage device 100. In some embodiments of the invention, the user 105 may, upon examining the claim chart, choose to reinvoke the iterative domain searcher 125 to perform more searching, leading to the production of one or more subsequent claim charts 160.

FIG. 2 illustrates a flow diagram of one embodiment of a method of performing automated letters patent analysis support carried out according to the principles of the invention. The method is divided into three portions: A, B and C.

The first portion, “A,” begins in a step 202. Software is invoked in a step 204. The identity of the user is checked in a step 206, typically by way of username and password. In a step 208, the user chooses one or more target documents (e.g., target letters patent) to analyze. In a step 210, the user enters a list of search directories. In a step 212, the user selects claims or sections in a target letters patent for 1^{st} level analysis. The key parameters may be automatically determined by auto-parsing the target letters patent. This is carried out in a step 214.

In a step 216, the user decides whether or not to enable key parameter stemming. Key parameter stemming allows near-matches searching to be performed on portions of key parameters as well as the full key parameters themselves. In a step 218, the target letters patent is automatically parsed and an interim report produced that indicates the number of key parameters derived. Typically, this interim report is displayed on a display device such that the user may interact with it to refine the set of key parameters. The A portion of the method ends in a step 220.

Next, a second portion, “B,” of the method begins in a step 222. In a step 224, the user may review the set of key parameters, adding or removing key parameters to or from the set to refine the set. In a step 226, the set of key parameters is displayed for the benefit of the user. In a step 228, the user is prompted for further review and refinement of the set of key parameters. If YES, the step 224 is performed. If NO, the user defines search criteria in a step 230. The user may, in the search criteria, accept only exact-match occurrences, or may loosen match constraints to allow differences in number, tense, misspellings, alternative spellings, synonyms or other differences as desired.

In a step 232, the user selects repositories (the specification, prosecution history or local or online databases that are to constitute the target search domain) to be searched. In a step 234, the target search domain is automatically searched a first time (a 1^{st} level search). An interim report conveying results of the automatic search may be provided in a step 236. The user may then, in a step 238, interact to refine the search in terms of refining the search criteria or the target search domain or may add or remove specific references from the target search domain. The B portion of the method ends in a step 240.

A third portion, “C,” of the method begins in a step 242. In a step 244, the user edits search criteria in accordance with the step 234. In a step 246, the target search domain is automatically searched a second time (a 2^{nd} level search). An interim report conveying results of the automatic search may be provided in a step 248. Subsequent iterations of search may be performed during the 2^{nd} level search as specified by the system or the user. The user may then, in a step 250, choose to produce a claim chart automatically. In a step 252, combinations of references may be analyzed to determine prima facie obviousness. The user may associate references manually or cause references to be automatically combined. In a step 254, the user may want to refine the set of key parameters further. In a step 256, the user may want to refine the search criteria or the target search domain or may add or remove specific references from the target search domain. In a step 258, the target search domain is automatically searched one or more subsequent times (one or more N^{th} level searches). An interim report conveying results of the automatic search may be provided in a step 260. The user may then, in a step 262, choose to produce a claim chart automatically.

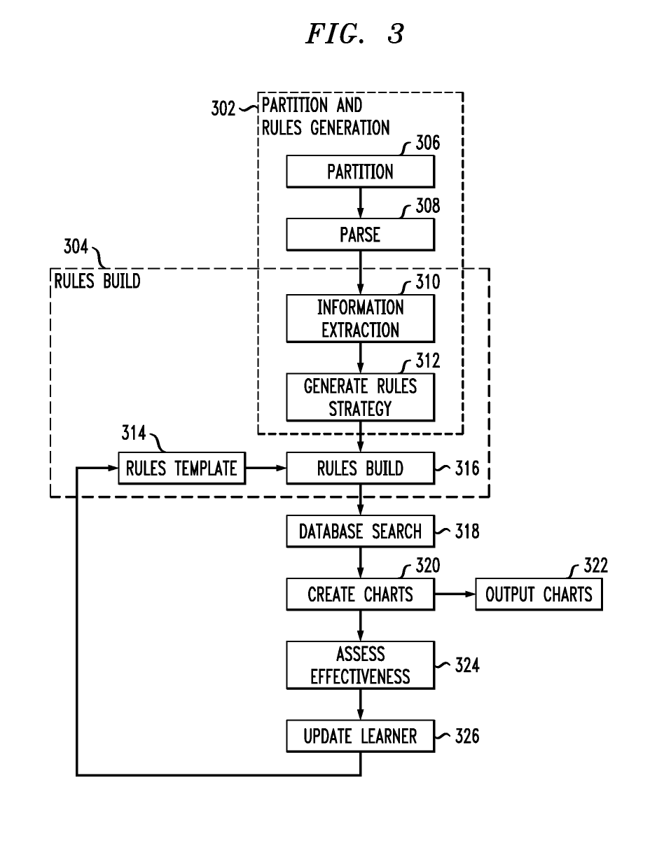

FIG. 3 illustrates a block diagram of one embodiment of a dissector process that may be carried out in the system of FIG. 1 or the method of FIG. 2. The dissector process is one way to parse a document (such as patent claims in target letters patent) for key parameters. A document is partitioned and parse rules generated in a section 302. Parse rules are built in a section 304.

A document is first partitioned in a step 306. In a step 308, the document is initially parsed for occurrences of key parameters. In a step 310, information (key parameters and locations thereof in the document) is extracted. In a step 312, initial parsing rules are developed. The initial parsing rules are placed in an initial rules template in a step 316. The parsing rules are then employed to search a database (the target search domain) in a step 318. Reports (charts) are created in a step 320 and displayed or printed in a step 322. The effectiveness of the initial parsing rules is assessed in a step 324. A learner (a known object capable of generating templates for parsing rules) is updated based on the assessment in a step 326. The result, which takes the form of an updated rules template (step 314), is employed to contain the initial parsing rules, and the dissector process continues until the parsing template is assessed as adequate.

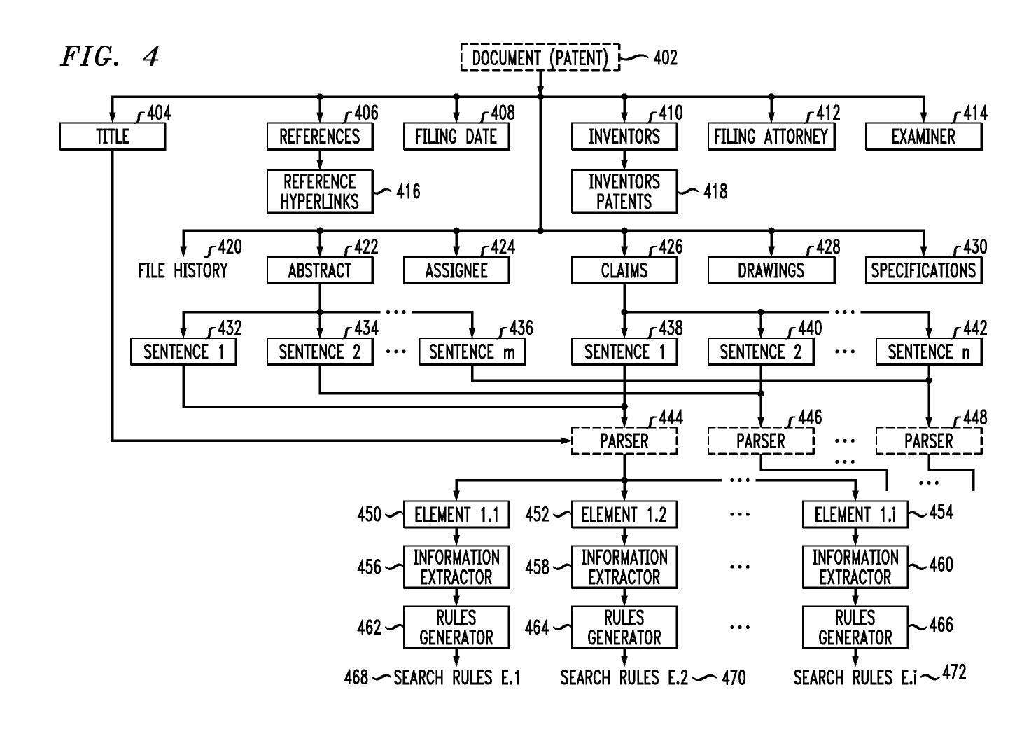

FIG. 4 illustrates a block diagram showing how a document, such as letters patent, may be partitioned according to the dissector process of FIG. 3, particularly the step 306. FIG. 4 conceptually illustrates a document in hierarchical form.

At the top of the hierarchy is the whole document 402. Below that level, the document may be divided into sections representing a title 404, references 406, filing date 408, inventor(s) 410, filing attorney 412, examiner 414, abstract 422, assignee 424, claims 426, drawings 428 and detailed description 430. The references 406 may have associated hyperlinks 416. The inventors 410 may have associated other patents or publications 418. A prosecution (or “file”) history 420 may be associated with the document, but is not within the four corners of the document itself.

The sections may be divided into sentences. For example, the abstract may have a sentence 1 432, a sentence 2 and a sentence m 436. Likewise, the claims may have a sentence 1 438, a sentence 2 440 and a sentence n 432. Each sentence in the claims section of letters patent is a separate claim, as the Background of the Invention section above describes.

To parse sentence 1 438 (claim 1), sentence 1 438 and, e.g., the title 404 and sentence 1 432 of the abstract are provided to a parser 444. Likewise, sentences of each of the claims are provided to the same or other parsers 446, 448. The result of this parsing is a plurality of elements (e.g., element 1.1 450, element 1.2 452, element 1.3 454) of each claim (e.g., sentence 1 438). Information extractors 456, 458, 460 operate on the respective elements (e.g., element 1.1 450, element 1.2 452, element 1.3 454) to produce information that is provided, in turn, to parsing rules generators 462, 464, 466. The parsing rules generators 462, 464, 466 in turn produce parsing rules that become search rules (e.g., search rules E.1 468, search rules E.2 470, search rules E.i 472). The search rules may be used in subsequent searches of the target search domain.

FIG. 5 is a diagram illustrating the generation of search rules pertaining to letters patent in accordance with the system of FIG. 1 or the method of FIG. 2. Many different types of search rules may be generated, but several examples will be illustrated and discussed here.

One is generation of Boolean search rules 502. A Boolean search rule is, for example the occurrence of two key parameters in the same reference (AND), the occurrence of one of two key parameters in the same reference (OR) or the occurrence of only one of two key parameters in the same reference (XOR).

Another is generation of proximity search rules 504. A proximity search rule is, for example the occurrence of two key parameters in the same sentence, paragraph or page of a reference or the occurrence of two key parameters within a specified number of words (e.g., 10) of each other.

Yet another is generation of contextual search rules 506. A contextual search rule is, for example the occurrence of a key parameter in the same paragraph (context) as other key parameters.

Still another is generation of conceptual search rules 508. A conceptual search rule is the occurrence of concept that involves a key parameter. For example, a key parameter may be “transistor,” but the concept may be switching. Thus any discussion of switching may be of interest.

Still yet another is generation of independent/dependent claim rules 510. One may make search rules dependent upon whether the key parameter in question is located in an independent claim as opposed to a dependent claim. For example, a key parameter located in an independent claim may be the subject of a conceptual search, but the same key parameter located in a dependent claim may only be the subject of an exact match.

Another is generation of claim differentiation search rules 512. A claim differentiation search rule may call for a key parameter located in an independent claim to be searched in a broader context than a related, but more specific key parameter in a dependent claim. The idea is to respect the doctrine of claim differentiation in the search that is performed, if such is desired.

Yet another is generation of motivation to combine search rules 514. Some key parameters may be regarded as more easily associated by a person having ordinary skill in the art (a “PHOSITA”). Thus, a motivation to combine search rule may give more latitude to co-occurrences of two key parameters (e.g., located in the same reference) than other key parameters (e.g., located in the same paragraph).

Still another is generation of prosecution history search rules 516. Statements made during prosecution typically have far greater evidentiary weight than statements appearing in references. Thus, search rules may have greater latitude when the target search domain is the prosecution history of the letters patent in question.

Still yet another is generation of “inventor's other invention” search rules 518. Statements made by an inventor in other references, including other patent applications or letters patent, may have greater evidentiary weight than statements made by noninventors in other references. Thus, search rules may have greater latitude when the target search domain includes other references, including other patent applications or letters patent, created by the inventor.

Another is generation of “continuation-in-part (CIP) and other line patents” search rules 520. Statements made by an inventor in related patent applications or letters patent may have greater evidentiary weight than statements made by the inventor in other references. Thus, search rules may have greater latitude when the target search domain includes other references, including related patent applications or letters patent created by the inventor.

Yet another is generation of other search rules 522. Those skilled in the pertinent art understand that any search rule may be found helpful in a particular context. The invention encompasses all conventional and later-developed search rules. Once search rules are developed, they are presented to the user for review and possible modification in a step 524. This process is iterative irrespective of the number of iterations actually undertaken in a given search.

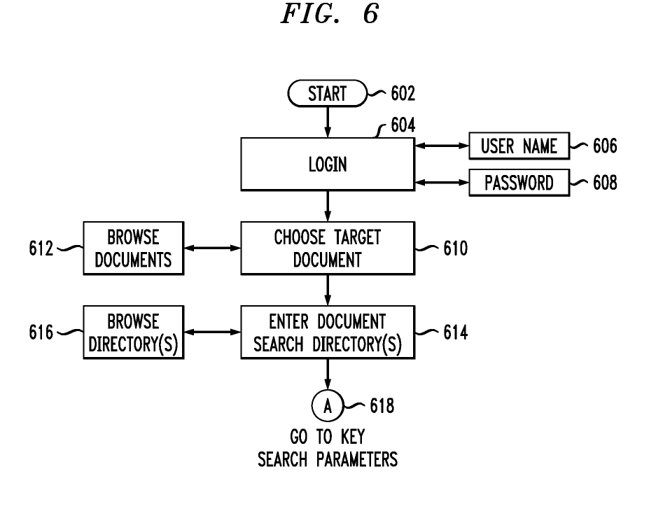

FIG. 6 illustrates a flow diagram of one embodiment of a more detailed first portion of the method of FIG. 2. Software for providing automated support of analysis of letters patent is invoked (by running or browsing) in a step 602. The identity of the user is checked in a step 604, typically by way of username 606 and password 608. In a step 610, the user chooses one or more target documents (target letters patent) to analyze, typically by browsing documents in a step 612. In a step 614, the user enters a list of search directories, typically by browsing directories in a step 616. The first portion ends in a step 618, wherein key parameters may then be searched.

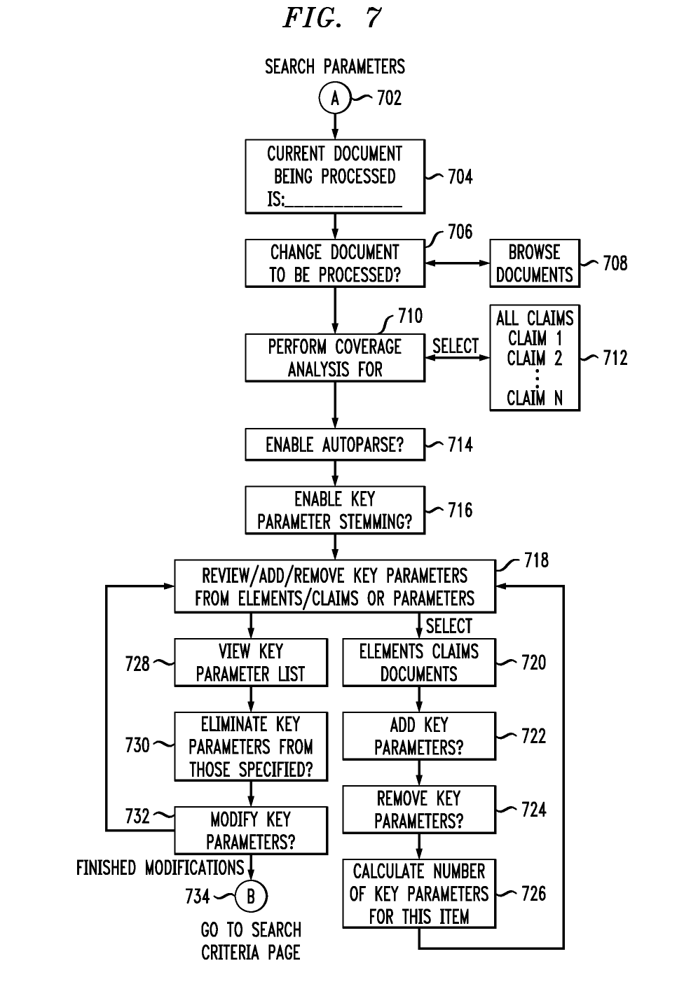

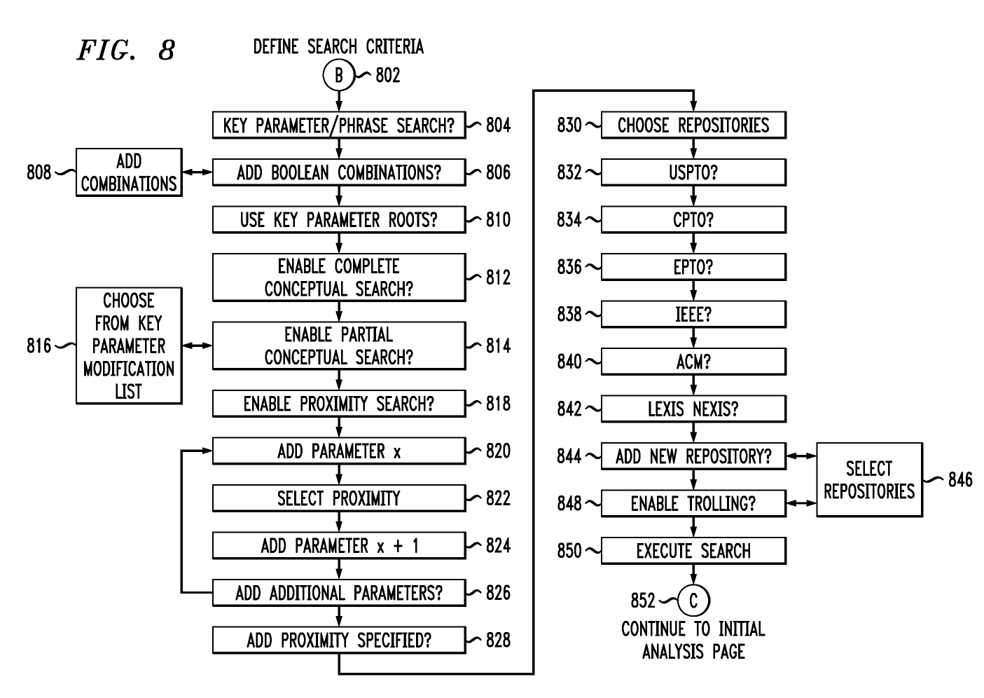

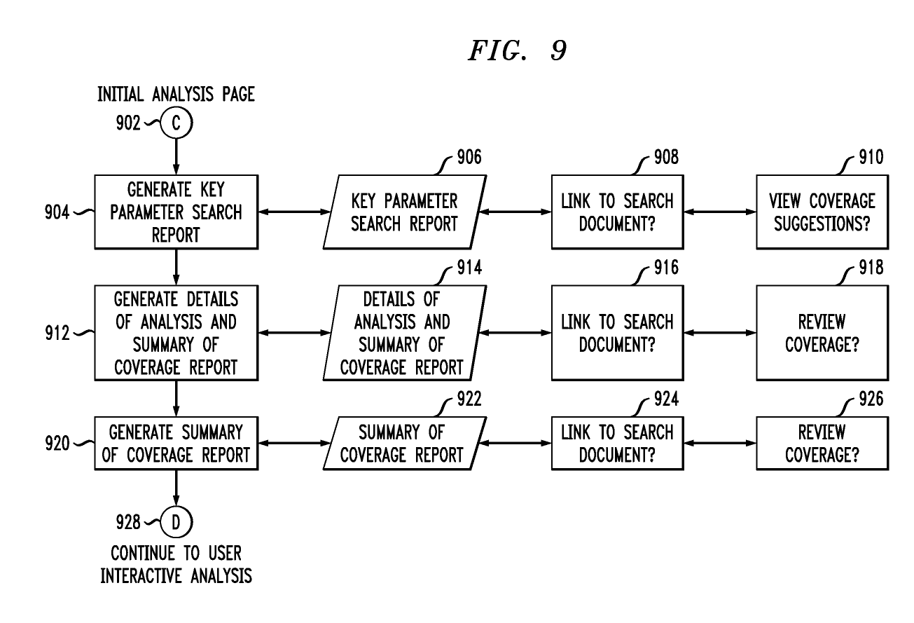

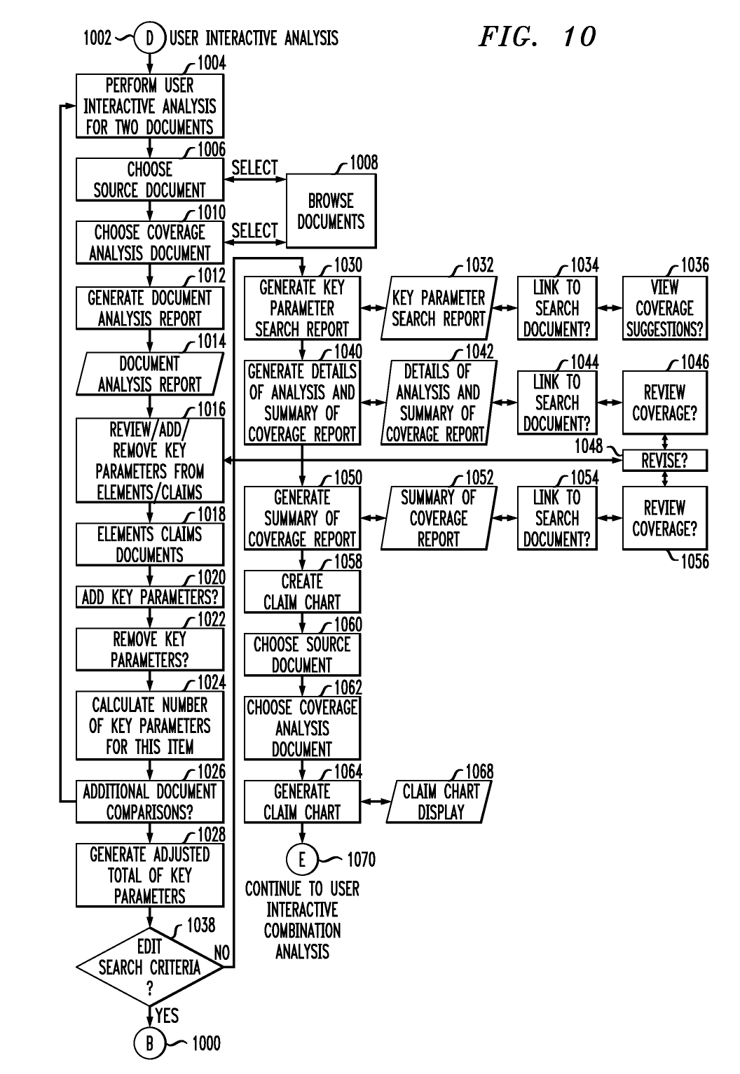

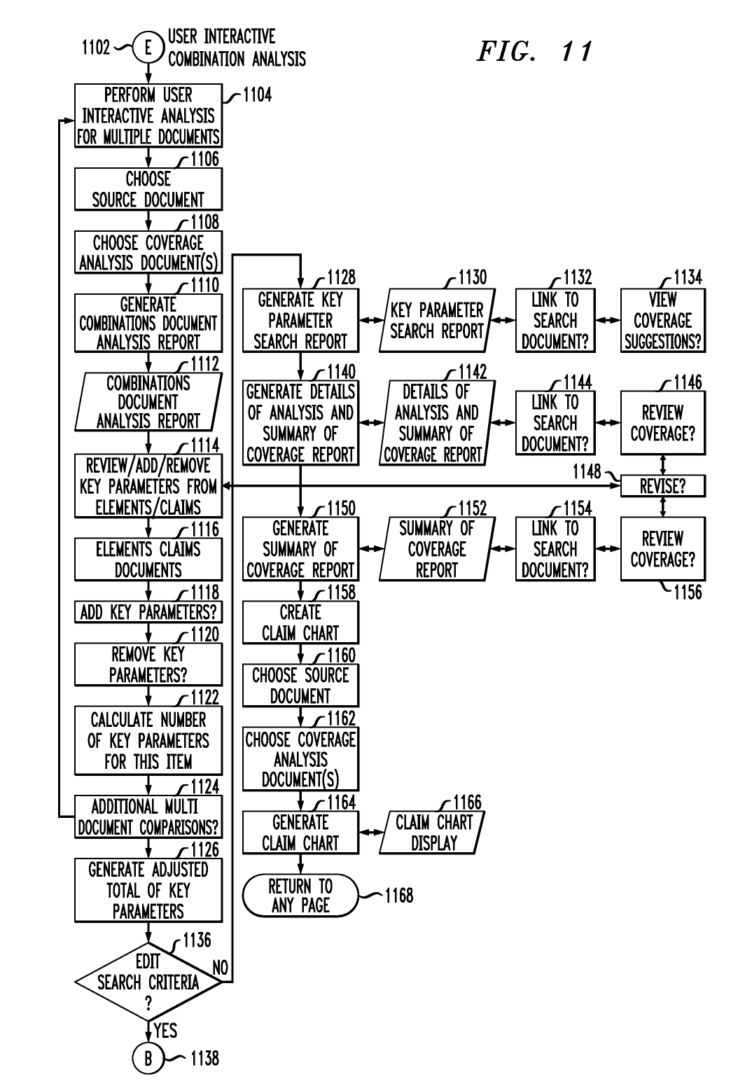

FIG. 7 illustrates a flow diagram of one embodiment of a more detailed second portion of the method of FIG. 2. The second portion begins in a step 702. In a step 704, the document is specified for 1^{st} level analysis. In a step 706, the user may select another or additional letters patent for analysis. The user may browse documents for any other or further letters patent in a step 708. Otherwise, the user may determine whether to perform an analysis of some or all claims of the target letters patent in a step 710. The user may make claim selections in a step 712. Then, in a step 714, the key parameters may be automatically determined by auto-parsing the target letters patent.

In a step 716, the user decides whether or not to enable key parameter stemming. As stated above, key parameter stemming allows near-matches searching to be performed on portions of key parameters as well as the full key parameters themselves. The target letters patent is automatically parsed and an interim report produced that indicates the number of key parameters derived and the key parameters themselves in a step 718. This interim report is displayed on a display device, allowing the user to interact with it to refine the set of key parameters in a step 720 by adding or removing key parameters to or from the set to refine the set. The user then has the opportunity to add one or more key parameters with respect to specific claim elements, claims or letters patent; a step 722 allows such. The user then has the opportunity to remove one or more key parameters; a step 724 allows such. The number of key parameters remaining in the set following this round of adding and subtracting is calculated in a step 726.

Then the user is afforded the opportunity to view the key parameter set as a whole in a step 728. The user can then eliminate key parameters in a step 730 or modify the key parameters in a step 732. After this overall review, the set of key parameters may then be searched.

FIG. 8 illustrates a flow diagram of one embodiment of a more detailed third portion of the method of FIG. 2. The third portion begins in a step 802. The user decides whether or not to perform a key parameter search in a step 804. The user can then decide whether to search Boolean combinations of key parameters in a step 806. If the user wants to search Boolean combinations, a step 808 allows the user to specify those combinations. The user then decides whether or not to use key parameter roots in a step 810. Then, in a step 812, the user can specify whether or not to enable a partial conceptual search. If so, the user can choose acceptable modifications of each of the key parameters in a step 816.

The user then may choose whether or not to search for proximity of multiple key parameters in a step 818. If so, the user may add a first key parameter in a step 820, select the appropriate proximity in a step 822 and add a second key parameter that is to have that proximity to the first key parameter in a step 824. In steps 826 and 828, the user is afforded the opportunity to add further parameters and proximities.

In a step 830, the user begins a process of defining the target search domain (or repositories). For the purposes of FIG. 8, it is assumed that online databases primarily form the target search domain (although such online databases or portions thereof could advantageously be copied to local storage to increase search speed). Accordingly, the user may select the United States Patent and Trademark Office patent and/or application database in a step 832, the Canadian Patent Office patent and/or application database in a step 834, the European Patent Office patent and/or application database in a step 836, the Institute of Electrical and Electronics Engineers technical publication database in a step 838, the Association for Computing Machinery technical database in a step 840 and the Lexis/Nexis database in a step 842. Those skilled in the pertinent art will understand that any database may be included in or omitted from this selection process.

In a step 844, the user can choose whether or not to add other repositories (such as the specification, prosecution history or local or other online databases that are to constitute the target search domain). If so, the user can add such other repositories in a step 846.

Then, in a step 848, the user can choose whether or not to enable indiscriminate searching, or “trolling.” Trolling has the advantage of casting a large net for searching, but has the concomitant disadvantage of taking a longer time to return results.

In a step 850, the automated search (a 1^{st} level search) is carried out using the selected key parameters, Boolean, proximity and other relationships and target search domain. The third portion ends in a step 852, wherein initial analysis may then be carried out.

FIG. 9 illustrates a flow diagram of one embodiment of a more detailed fourth portion of the method of FIG. 2. The fourth portion begins in a step 902. Several different kinds of interim reports conveying results of the automatic search may be provided.

In a step 904, a key parameter search report is generated. The key parameter search report is provided to the user in a step 906. The key parameter search report may be printed out but may more advantageously be displayed on a display, which allows the report to contain hypertext links (or “hyperlinks”) to references contained in the report. The user may follow those hyperlinks to the references in a step 908 and review the search coverage in a step 910.

In a step 912, details of analysis and summary of coverage report is generated. The details of analysis and summary of coverage report is provided to the user in a step 914. The details of analysis and summary of coverage report may be printed out but may more advantageously be displayed on a display. The user may follow any hyperlinks in the report to the references in a step 916 and review the search coverage in a step 918.

In a step 920, a summary of coverage report is generated. The details of summary of coverage report are provided to the user in a step 922. The summary of coverage report may be printed out but may more advantageously be displayed on a display. The user may follow any hyperlinks in the report to the references in a step 924 and review the search coverage in a step 926. The fourth portion ends in a step 928, wherein the user may perform an interactive analysis of search results.

FIG. 10 illustrates a flow diagram of one embodiment of a more detailed fifth portion of the method of FIG. 2. The fifth portion begins in a step 1002. In a step 1004, the user performs an interactive analysis with respect to the claims of the target letters patent and a reference from the target search domain. The user chooses the claims in a step 1006 and the reference in a step 1010. Each of these may be chosen by browsing in a step 1008.

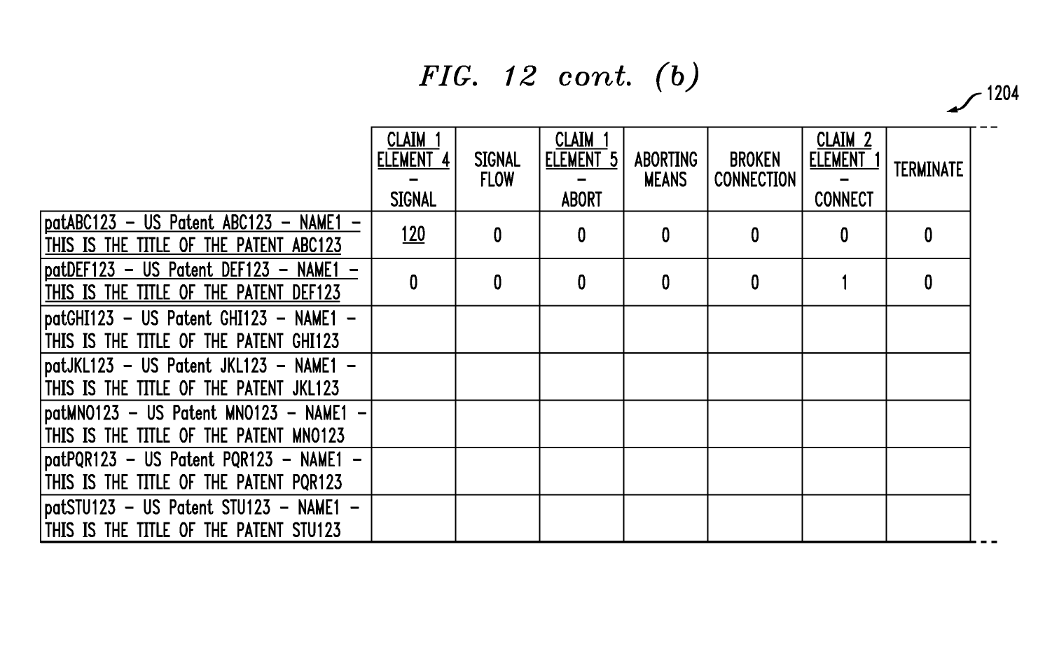

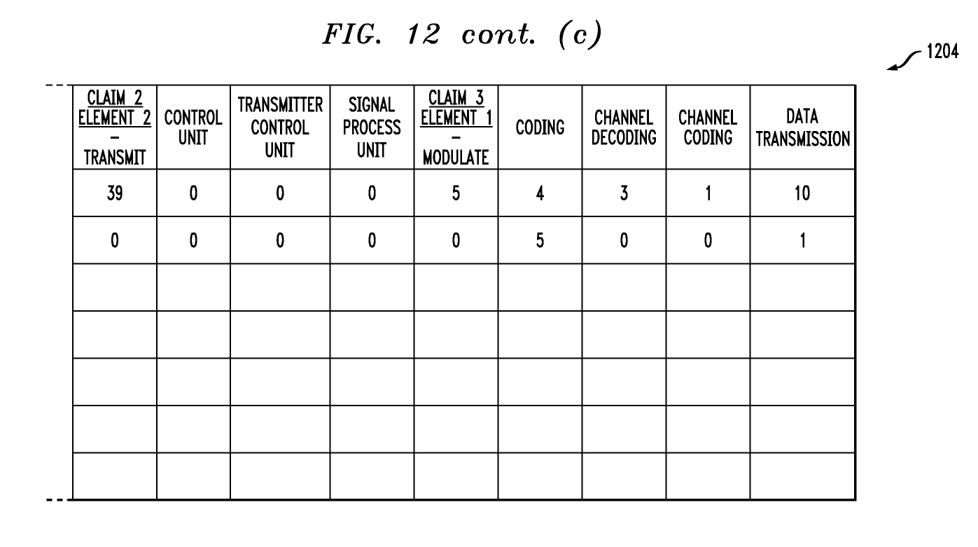

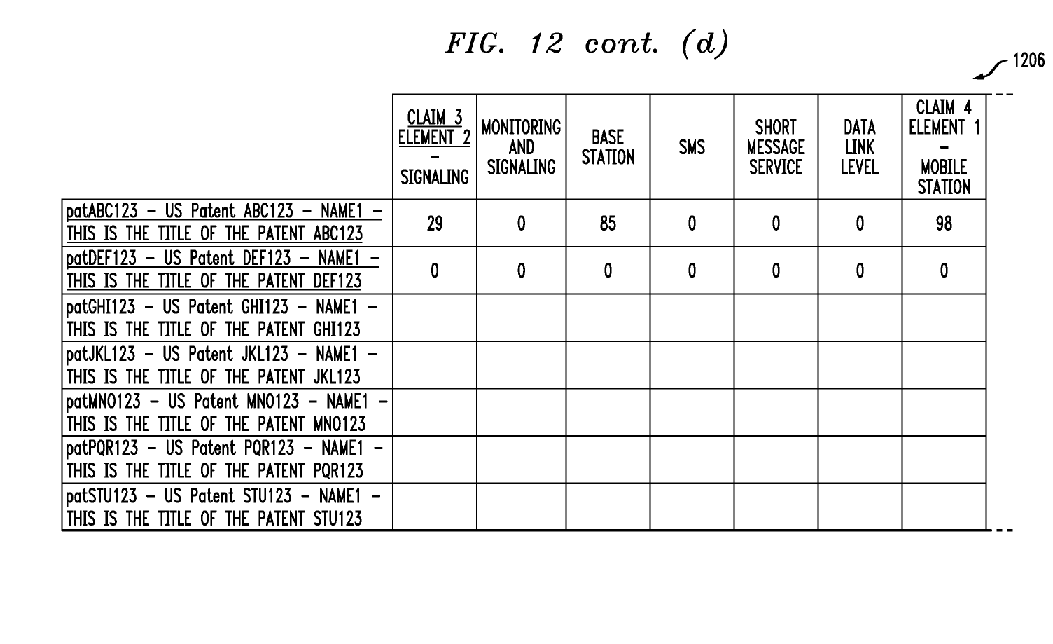

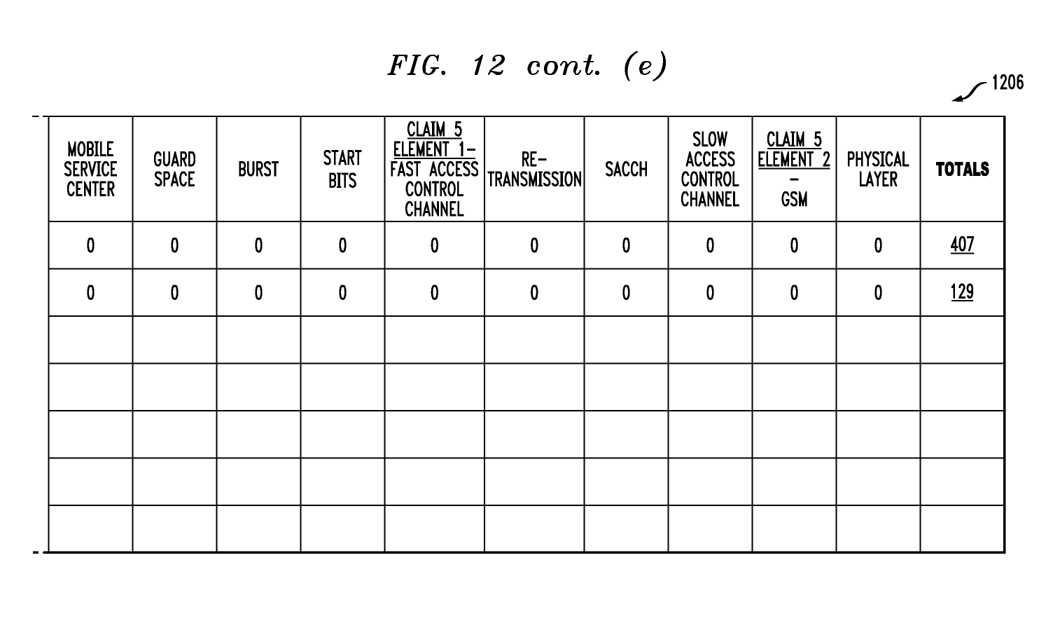

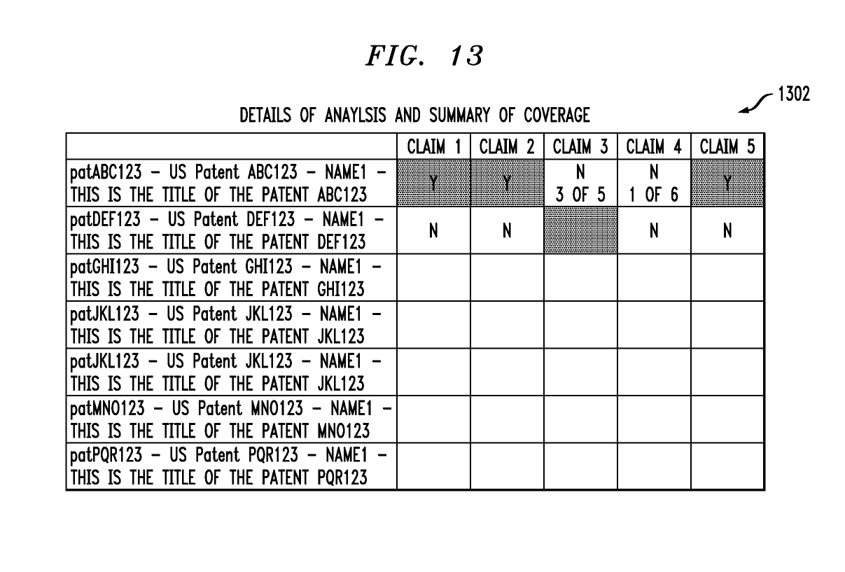

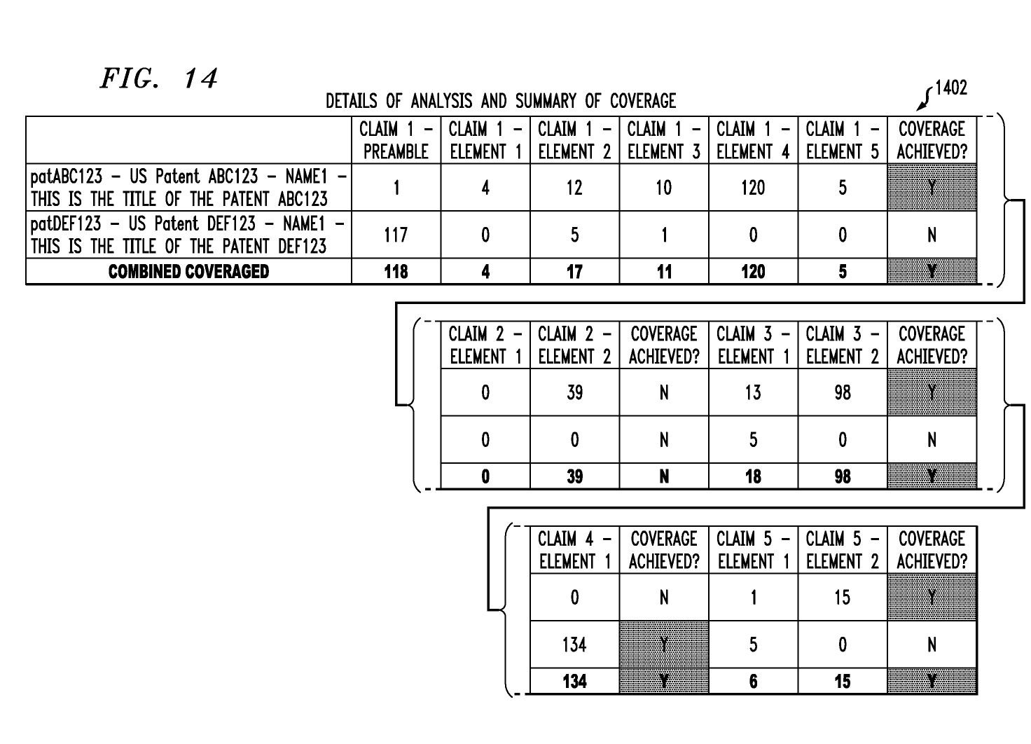

Based on these chosen documents, an interim document analysis report is generated in a step 1012 and presented in a step 1014. The interim document analysis report may take the form of that shown in FIG. 12. The user may then review the report and add and remove key parameters from the set as desired in a step 1016. This interim report is displayed on a display device, allowing the user to interact with it to refine the set of key parameters in a step 1018 by adding or removing key parameters to or from the set to refine the set. The user then has the opportunity to add one or more key parameters with respect to specific claim elements, claims or letters patent; a step 1020 allows such. The user then has the opportunity to remove one or more key parameters; a step 1022 allows such. The number of key parameters remaining in the set following this round of adding and subtracting is calculated in a step 1024.

In a step 1026, the user is allowed to perform additional document comparisons. If the user wants to perform such additional comparisons, the step 1004 is re-entered. If not, an adjusted total number of key parameters is generated in a step 1028.

The user is then allowed to edit search criteria in a step 1038. If he does not elect, the third portion of the method is re-entered in a step 1000. If he so elects, processing occurs similar to that detailed in conjunction with FIG. 9.

A key parameter search report is generated in a step 1030. The key parameter search report is provided to the user in a step 1032 and may take a form such as that shown in FIG. 12. The key parameter search report may be printed out but may more advantageously be displayed on a display, which allows the report to contain hyperlinks to references contained in the report. The user may follow those hyperlinks to the references in a step 1034 and review the search coverage in a step 1036.

In a step 1040, a detail of analysis and summary of coverage report is generated. The details of analysis and summary of coverage report is provided to the user in a step 1042 and may take a form such as that described in conjunction with FIG. 13. The details of analysis and summary of coverage report may be printed out but may more advantageously be displayed on a display. The user may follow any hyperlinks in the report to the references in a step 1044 and review the search coverage in a step 1046. If the user desires to make further revisions, a step 1048 allows the user to return to the step 1016.

In a step 1050, a summary of coverage report is generated. The details of summary of coverage report are provided to the user in a step 1052 and may take a form such as that shown in FIG. 13. The summary of coverage report may be printed out but may more advantageously be displayed on a display. The user may follow any hyperlinks in the report to the references in a step 1054 and review the search coverage in a step 1056. If the user desires to make further revisions, the step 1048 again allows the user to return to the step 1016.

At this point, the user can create a claim chart in a step 1058. The user chooses a target letters patent in a step 1060, a reference from the target search domain in a step 1062 and generates the claim chart in a step 1064. The claim chart may be displayed or printed in a step 1068 at which point the fifth portion of the method ends. Alternatively, if the user wishes to perform an analysis based on combinations of references, the fifth portion of the method ends in a step 1070, wherein the user may begin to perform an analysis based on combinations of references.

FIG. 11 illustrates a flow diagram of one embodiment of a more detailed sixth portion of the method of FIG. 2. The sixth portion begins in a step 1102. In a step 1104, the user performs an interactive analysis with respect to the claims of the target letters patent and two or more references from the target search domain to determine prima facie obviousness. The user chooses the claims in a step 1106 and the references in a step 1108. Each of these may be chosen by browsing.

Based on these chosen documents, an interim document analysis report is generated in a step 1110 and presented in a step 1112. The interim document analysis report may take the form of that shown in FIG. 12. The user may then review the report and add and remove key parameters from the set as desired in a step 1114. This interim report is displayed on a display device, allowing the user to interact with it to refine the set of key parameters in a step 1116 by adding or removing key parameters to or from the set to refine the set. The user then has the opportunity to add one or more key parameters with respect to specific claim elements, claims or letters patent; a step 1118 allows such. The user then has the opportunity to remove one or more key parameters; a step 1120 allows such. The number of key parameters remaining in the set following this round of adding and subtracting is calculated in a step 1122.

In a step 1124, the user is allowed to perform additional document comparisons. If the user wants to perform such additional comparisons, the step 1104 is re-entered. If not, an adjusted total number of key parameters is generated in a step 1126.

The user is then allowed to edit search criteria in a step 1136. If he does not elect, the third portion of the method is re-entered in a step 1138. If he so elects, processing occurs similar to that detailed in conjunction with FIG. 9.

A key parameter search report is generated in a step 1128. The key parameter search report is provided to the user in a step 1130 and may take a form such as that shown in FIG. 12. The key parameter search report may be printed out but may more advantageously be displayed on a display, which allows the report to contain hyperlinks to references contained in the report. The user may follow those hyperlinks to the references in a step 1132 and review the search coverage in a step 1134.

In a step 1140, a detail of analysis and summary of coverage report is generated. The details of analysis and summary of coverage report is provided to the user in a step 1142 and may take a form such as that described in conjunction with FIG. 14. The details of analysis and summary of coverage report may be printed out but may more advantageously be displayed on a display. The user may follow any hyperlinks in the report to the references in a step 1144 and review the search coverage in a step 1146. If the user desires to make further revisions, a step 1148 allows the user to return to the step 1114.

In a step 1150, a summary of coverage report is generated. The details of summary of coverage report are provided to the user in a step 1152 and may take a form such as that shown in FIG. 14. The summary of coverage report may be printed out but may more advantageously be displayed on a display. The user may follow any hyperlinks in the report to the references in a step 1154 and review the search coverage in a step 1156. If the user desires to make further revisions, the step 1148 again allows the user to return to the step 1114.

At this point, the user can create a claim chart in a step 1158. The user chooses a target letters patent in a step 1160, two or more references from the target search domain in a step 1162 and generates the claim chart in a step 1164. The claim chart may be displayed or printed in a step 1166 at which point the sixth portion of the method ends. The user can, if he so elects, to return to any portion of the method in a step 1168.

FIG. 12 illustrates one embodiment of a first interim report, a key parameter search report, comprising report portions 1202, 1204, 1206, that may be generated by the system of FIG. 1 or the method of FIG. 2. The first interim report organizes occurrences of key parameters by claim and by reference. Columns in the report portions 1202, 1204, 1206 set forth the key parameters, arranged in the order that they occur in the claims; the key parameters may be hyperlinks, allowing the user to study them in context. Each row in the report portions 1202, 1204, 1206 is directed to a different reference; the leftmost column of each row lists the reference for that row. Each cell representing an intersection of a key parameter and a reference contains a numeral representing the number of times that key parameter occurs in that reference. Each numeral may be a hyperlink, allowing the user to study the context of each occurrence in context. The rightmost column of each row lists the total number of occurrences of key parameters for that reference.

FIG. 13 illustrates one embodiment of a second interim report 1302, a detail of analysis and summary of coverage report pertaining to an anticipation analysis, that may be generated by the system of FIG. 1 or the method of FIG. 2.

In one embodiment, the second interim report 1302 organizes occurrences of key parameters by claim element and by reference. Columns in the second interim report 1302 list the preamble and each element of each claim of the target letters patent; the elements may be hyperlinks, allowing the user to study them in context. Each row in the second interim report 1302 is directed to a different reference; the leftmost column of each row lists the reference for that row. Each cell representing an intersection of a preamble or element and a reference contains a numeral representing the number of times that the key parameters in those elements occur in that reference. Each numeral may be a hyperlink, allowing the user to study the context of each occurrence in context. Each claim of the target letters patent is also assigned a column for the purpose of indicating whether or not a reference contains occurrences of all key parameters (preamble and element) of that claim. An indication that a reference contains occurrences of all key parameters (preamble and element) of a given claim is evidence that the reference is an anticipating reference.

In another embodiment, the details of analysis and summary of coverage report 1302 gives slightly less detail than the embodiment described above. Namely, the many columns dedicated to preambles and elements of each claim are eliminated. Instead, each column pertains to a given claim in the target letters patent. Each cell representing an intersection of a claim and a reference contains a “Y” or an “N” indicating whether or not that reference contains occurrences of all key parameters associated with that claim. If not, the number of elements in which all key parameters do contain occurrences in that reference is listed. Referring to the second interim report of FIG. 13, it is apparent that the first reference contains all key parameters associated with all elements of Claims 1, 2 and 5 of the target letters patent, but only 3 of 5 of the elements of Claim 3 and only 1 of the 6 elements of Claim 4.

FIG. 14 illustrates one embodiment of a third interim report, a details of analysis and summary of coverage report pertaining to an obviousness analysis, that may be generated by the system of FIG. 1 or the method of FIG. 2. The third interim report 1402 organizes occurrences of key parameters by claim element and by reference. Columns in the fourth interim report 1402 list the preamble and each element of each claim of the target letters patent; the elements may be hyperlinks, allowing the user to study them in context. Each row in the fourth interim report 1402 is directed to a different reference; the leftmost column of each row lists the reference for that row. Each cell representing an intersection of a preamble or element and a reference contains a numeral representing the number of times that the key parameters in those elements occur in that reference. Each numeral may be a hyperlink, allowing the user to study the context of each occurrence in context. Each claim of the target letters patent is also assigned a column for the purpose of indicating whether or not a reference contains occurrences of all key parameters (preamble and element) of that claim. An indication that a reference contains occurrences of all key parameters (preamble and element) of a given claim is evidence that the reference is an anticipating reference.

The lowest row of the third interim report 1402 contains an indication of the combined coverage of the references. In the example of FIG. 14, each cell in the lowest row contains a numeral representing the sum of the numbers of occurrences of each key parameter in either of the references. Likewise, cells in the lowest row that underlie the columns that indicate whether or not a reference contains occurrences of all key parameters (preamble and element) of that claim are used to indicate whether the combination of references contains occurrences of all key parameters of that claim.

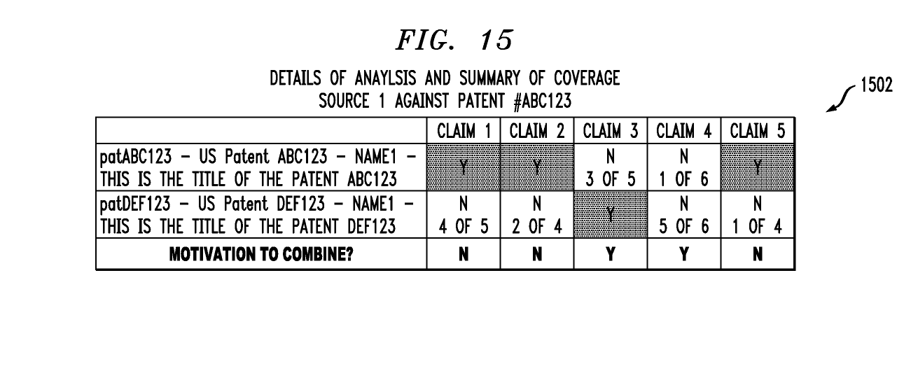

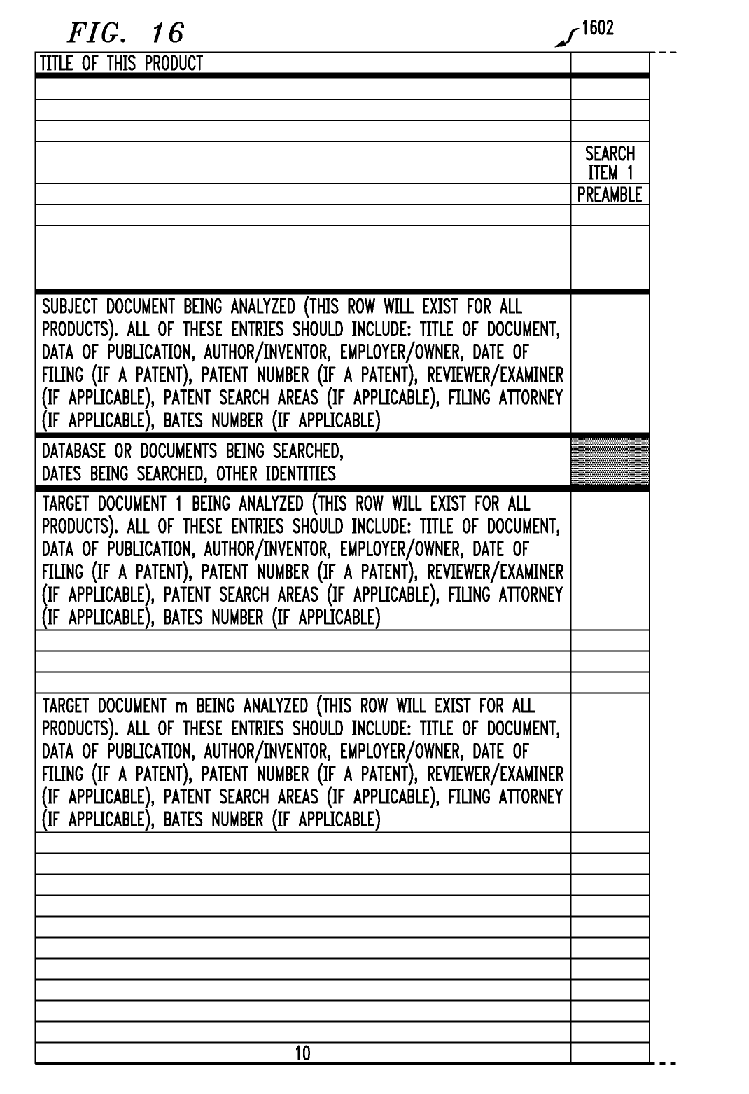

FIG. 15 illustrates one embodiment of a fourth interim report, a summary of coverage report pertaining to a motivation to combine analysis, that may be generated by the system of FIG. 1 or the method of FIG. 2. Each column pertains to a given claim in the target letters patent. Each cell representing an intersection of a claim and a reference contains a “Y” or an “N” indicating whether or not that reference contains occurrences of all key parameters associated with that claim. If not, the number of elements in which all key parameters do contain occurrences in that reference is listed. The lowest row indicates whether or not a motivation to combine exists as to the references with respect to each claim. For example, with respect to Claims 1, 2 and 5, the primary reference (“ABC123”) teaches all limitations; thus no motivation exists to combine the secondary reference (“DEF123”). With respect to Claims 3 and 4, the primary reference lacks all limitations, giving rise to a potential motivation to combine the secondary reference. Of course, motivations to combine are complex and require user analysis. However, the fourth interim report is helpful in narrowing down the references and claims that the user may want to consider. For example, for Claim 4 the combined references achieve coverage, as indicated by a Y in the Motivation to Combine row.

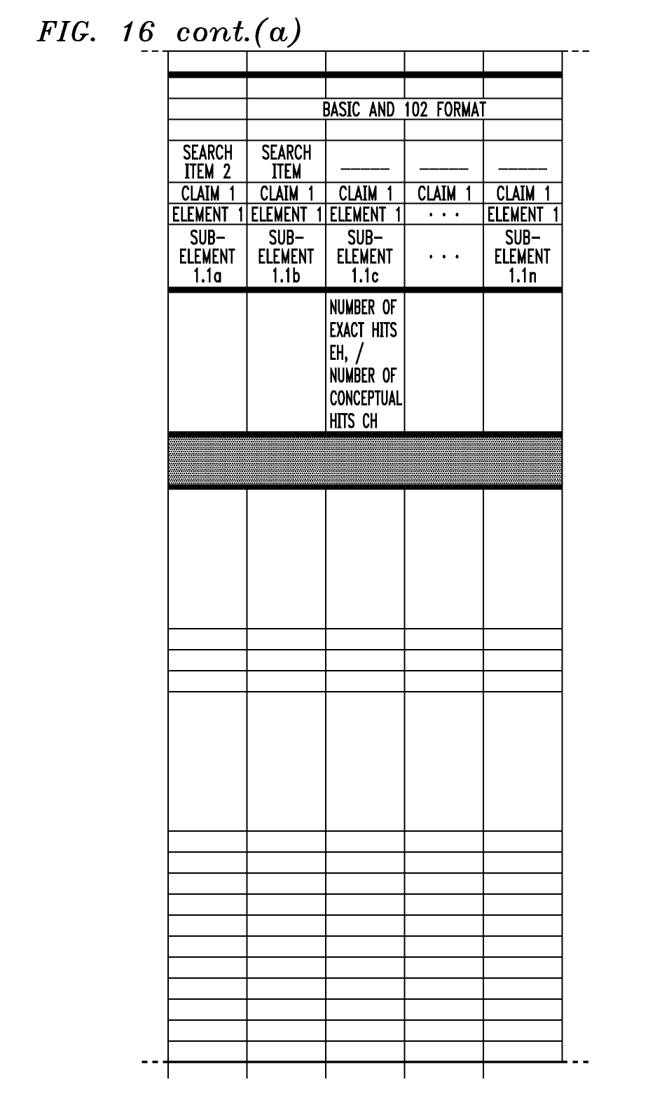

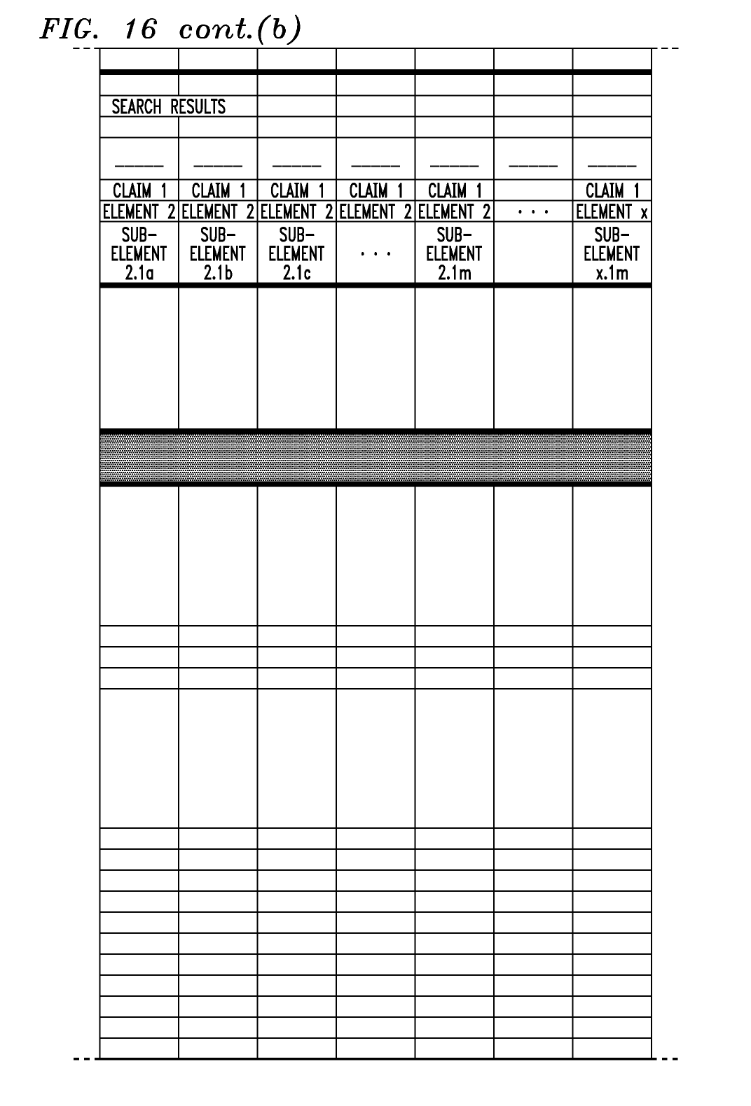

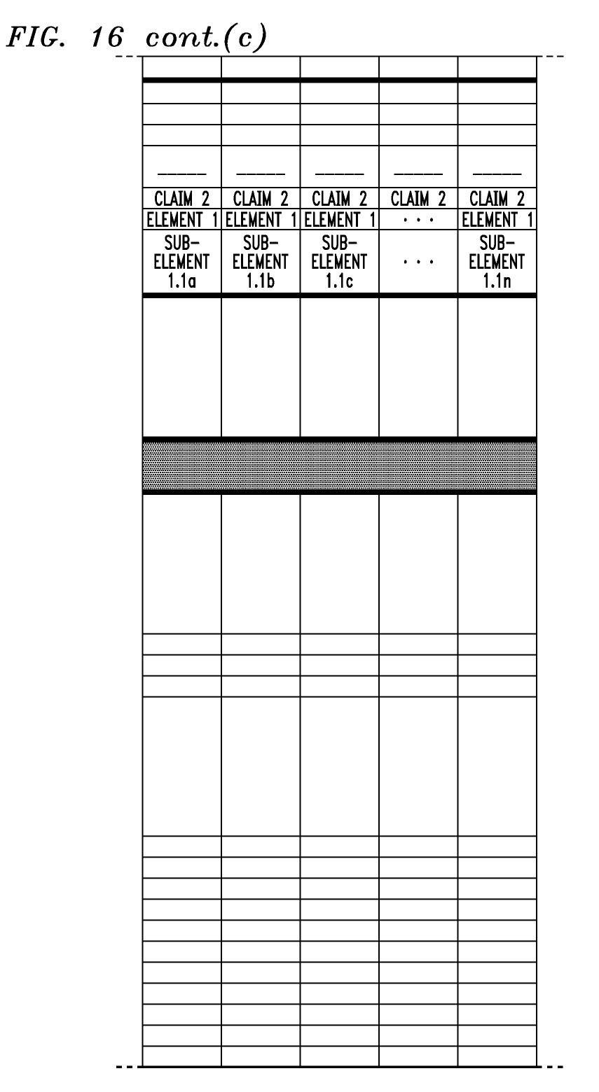

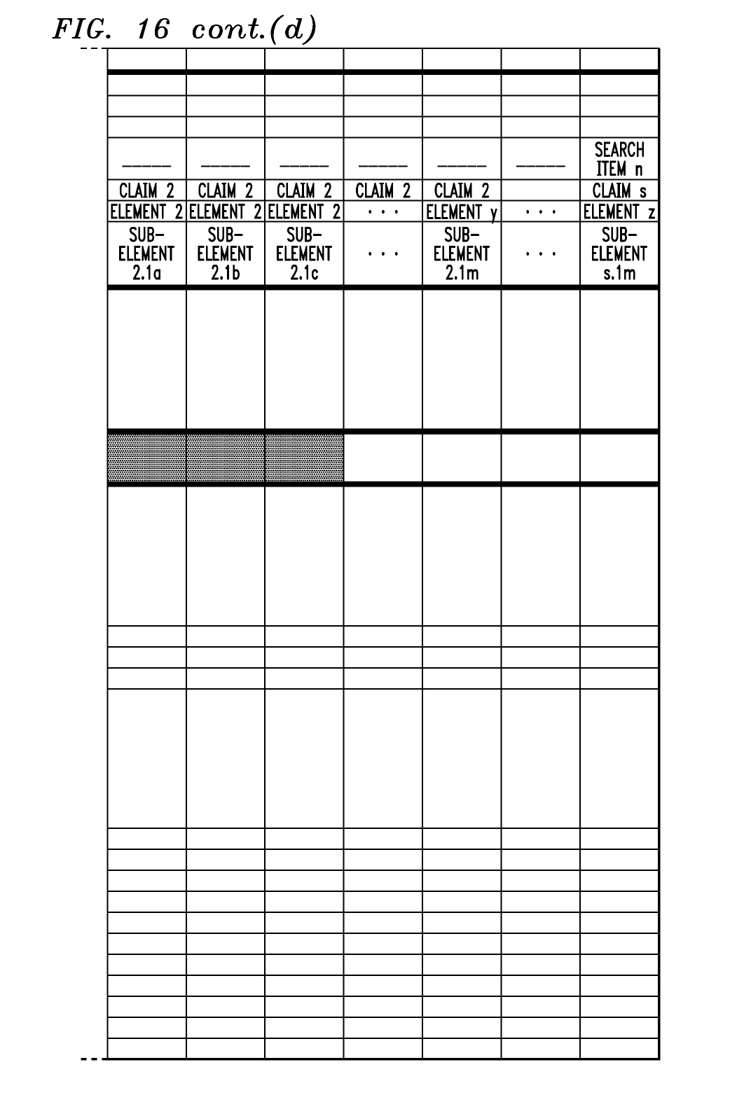

FIG. 16 illustrates one embodiment of a claim chart 1602 that may be generated by the system of FIG. 1 or the method of FIG. 2. Those skilled in the pertinent art are familiar with claim charts and their widely recognized utility for conducting patent analysis. The illustrated claim chart has a familiar structure and function; however the invention is not limited to the illustrated form of claim chart.

The claim chart 1602 organizes occurrences of key parameters by claim element and by reference. Columns in the claim chart 1602 are broken down based on the search rules used for analyzing the claims of the letters patent. The key parameters are listed along with numerals representing the number of occurrences of such key parameters in the references. The key parameters may be hyperlinks, allowing the user to study them in context. Each row in the third interim report 1602 sets forth occurrences of those key parameters in references in context. Each cell representing an intersection of a key parameter and an occurrence contains a numeral representing the number of times that the key parameters occur in context in that reference. Each numeral may be a hyperlink, allowing the user to study the context of each occurrence in context. Each claim of the target letters patent is also assigned a column for the purpose of indicating whether or not a reference contains occurrences of all key parameters (preamble and element) of that claim. Occurrences of all key parameters in a single reference are evidence of an anticipating reference. Occurrences of all key parameters in two or more references are evidence of a combination of reference that may constitute prima facie obviousness.

Although the invention has been described in detail, those skilled in the pertinent art should understand that they can make various changes, substitutions and alterations herein without departing from the scope of the invention in its broadest form.

What is claimed is:

1. An automated document analysis support system, comprising:
a document parser configured to scan at least one item in target document and derive therefrom a set of key parameters;
a rule generator associated with said document parser and configured iteratively to:
solicit user input regarding key parameters to be included in said set,
employ said set to generate search rules to be used for searching, and
solicit said user input regarding said search rules;
an iterative domain searcher associated with said rule generator and configured iteratively to:
search a target search domain for said key parameters using said search rules, and
provide at least one interim report containing occurrences of at least some of said key parameters in said target search domain; and
a chart generator associated with said iterative domain searcher and configured to generate a chart regarding said item and based on said at least one interim report.

2. The system as recited in claim 1 wherein said key parameters are selected from the group consisting of:
word fragments,
words,
sets of words,
phrases,
acronyms,
claim limitations, and
claim elements.

3. The system as recited in claim 1 wherein said target search domain is a specification of said target document.

4. The system as recited in claim 1 wherein said target search domain is a database of prior art references selected from the group consisting of:
at least one local database, and
at least one online database.

5. The system as recited in claim 1 wherein said interim report indicates a number of occurrences in said target search domain of a key parameter of a given item.

6. The system as recited in claim 1 wherein said interim report indicates when a single reference in said target search domain contains all key parameters of a given item.

7. The system as recited in claim 1 wherein said interim report indicates when a combination of references in said target search domain contains all key parameters of a given item.

8. An automated document analysis support method, comprising:
scanning at least one item in a target document;
deriving from said target document a set of key parameters;
iteratively:
soliciting user input regarding key parameters to be included in said set,
employing said set to generate search rules to be used for searching,
soliciting said user input regarding said search rules,
searching a target search domain for said key parameters using said search rules, and
providing at least one interim report containing occurrences of at least some of said key parameters in said target search domain; and
generating a chart based on said interim report.

9. The method as recited in claim 8 wherein said key parameters are selected from the group consisting of:
word fragments,
words,
sets of words,
phrases,
acronyms,
claim limitations, and
claim elements.

10. The method as recited in claim 8 wherein said target search domain is a specification of said target document.

11. The method as recited in claim 8 wherein said target search domain is a database of prior art references selected from the group consisting of:
at least one local database, and
at least one online database.

12. The method as recited in claim 8 wherein said interim report indicates a number of occurrences in said target search domain of a key parameter of a given item.

13. The method as recited in claim 8 wherein said interim report indicates when a single reference in said target search domain contains all key parameters of a given item.

14. The method as recited in claim 8 wherein said interim report indicates when a combination of references in said target search domain contains all key parameters of a given item.

15. An automated Letters Patent analysis support system, comprising:
a document parser configured to scan claims in target letters patent and derive therefrom a set of limitations therefrom;
a rule generator associated with said document parser and configured iteratively to:
solicit user input regarding limitations to be included in said set,
employ said set to generate search rules to be used for searching, and
solicit said user input regarding said search rules;
an iterative domain searcher associated with said rule generator and configured iteratively to:
search a target search domain for said limitations using said search rules, and
provide interim reports containing occurrences of at least some of said limitations in said target search domain; and
a claim chart generator associated with said iterative domain searcher and configured to generate a claim chart based on said interim report.

16. The system as recited in claim 15 wherein said system is embodied in a web site.

17. The system as recited in claim 15 wherein said target search domain is a specification of said target letters patent.

18. The system as recited in claim 15 wherein said target search domain is a database of prior art references selected from the group consisting of:
at least one local database, and
at least one online database.

19. The system as recited in claim 15 wherein said interim report indicates a number of occurrences in said target search domain of a limitation of a given item.

20. The system as recited in claim 15 wherein said interim report indicates when a single reference in said target search domain contains all limitations of a given one of said claims.

21. The system as recited in claim 15 wherein said interim report indicates when a combination of references in said target search domain contains all limitations of a given one of said claims.
